(19) United States
(12) Patent Application Publication
(10) Pub. No.: US 2005/0154629 A1
(43) Pub. Date: Jul. 14, 2005

(54) Product purchasing trend analyzing system

(75) Inventors: Shuichi Matsuda, Maebashi (JP); Yoshiharu Shimada, Maebashi (JP); Tsuneji Ookawara, Maebashi (JP); Miyuki Sato, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/030,316

(22) Filed: Jan. 7, 2005

Related U.S. Application Data
(63) Continuation of application No. PCT/JP02/07022, filed on Jul. 10, 2002.

(51) Int. Cl. G06F 17/60

(52) U.S. Cl. 705/10

(57) ABSTRACT

A system for analyzing purchasing trends of products which manufacturers sell in stores, characterized by being provided with a server 1 communicably connected with first terminals 3 provided at manufacturers and second terminals 3 provided in stores, the server 1 provided with entry means enabling input of product information of products from the first terminals 3, product information display means for sending product information to and displaying it at the second terminals 2, and acquiring means for acquiring histories by which product information is accessed by the second terminals 2.

### CROSS-REFERENCE TO RELATED APPLICATION

This application is a continuation of, and claims priority from International PCT Application No. PCT/JP2002/007022, filed on Jul. 10, 2002, the contents being incorporated herein by reference,

### TECHNICAL FIELD

The present invention relates to a product information system, more particularly relates to a product purchasing trend analyzing system for acquiring in real time information up to when customers purchase products and analyzing purchasing trends of customers based on this information.

### BACKGROUND ART

Japanese Unexamined Patent Publication (Kokai) No. 2002-150432 discloses an invention entitled a “product information provision server and product information provision method”. This invention has as its object the provision of a product information provision server and product information provision method enabling analysis of information of unpurchased products which were not been sold, but which it is believed users wanted to buy or were interested in and thereby promoting sales of products. This configuration is characterized in that a server communicably connected to terminal devices installed in stores stores in an output history database and manages information relating to an output history of product information for which search or display is requested from the terminal devices based on user operation, stores and manages sold product information sent from host computers of POS systems connected to POS terminals of POS systems installed at cash registers etc. in stores, and specifies information on unpurchased products which were candidates for purchase but which failed to be purchased based on the output history information and sold product information.

The product information server according to this prior art only collects information on which customers purchased which products when analyzing purchased product information, so could not analyze what products were purchase candidates for each customer or from what perspectives customers purchased products in real time. Further, this server counted only what products were sold when analyzing product purchase information, so could not acquire in real time information as to which products were purchase candidates or which products were not purchase candidates. With the method of Japanese Unexamined Patent Publication (Kokai) No. 2002-150432, since only information on unpurchased products which were not sold, but which it is believed users wanted or were interested in was obtained, it was not possible to analyze information as to what perspectives customers purchased products from. Therefore, store managers were unable to judge in real time and suitably set the restocking quantities and prices of products which were purchase candidates or products which were not purchase candidates.

Further, according to the prior art, customers could not display on screens a comparison of items of specifications of competing manufacturers for the same products. They had to print out product information of different manufacturers for comparisons or make comparisons by product catalogs of product information in order to compare products. This took trouble.

Further, in stores, staff often end up being kept busy explaining products. The work which originally should be performed by the staff cannot therefore be completed. Further, with the method of Japanese Unexamined Patent Publication (Kokai) No. 2002-150432, since only information on unpurchased products which were not sold, but which it is believed users wanted or were interested in was obtained, it was not possible to analyze information as to which products were compared with which manufacturers or what perspectives customers purchased products from. Therefore, manufacturers have not been able to obtain in real time information relating to purchasing trends of products such as what products compete with what manufacturers and what perspectives customers use to determine purchases of products, that is, what the standards of judgment are for customers purchasing products, so have often left product development for later.

### DISCLOSURE OF INVENTION

The present invention has as its object the provision of a product purchasing trend analyzing system for acquiring and analyzing information relating to purchasing trends of products such as what kind of products are considered as purchase candidates when customers select products for purchase or what perspectives they select products for purchase from and notifying the information to stores in real time so as to enable them to judge in real time the restocking quantities or prices of products in the stores to enable these to be suitably set.

The present invention has as another object to notify manufacturers in real time of information as to what manufacturers are rival manufacturers of products and on what points (specifications) products purchased by customers are compared with products of rival manufacturers so as to enable manufacturers to timely develop products along with the constantly changing trends of purchase of products by customers (consumers).

The product purchasing trend analyzing system according to the present invention for achieving the above objects is characterized by storing in a customer purchasing trend database a history relating to products which customers view and items of specifications of the products when customers view product information for comparison or purchase products and analyzing this information to analyze the selected products (names of products of purchase candidates) and selected items (purchasing perspectives of products) in customer units and product units.

The product purchasing trend analyzing system according to the present invention for achieving the above objects provides a system for analyzing purchasing trends of products which manufacturers sell in stores, characterized by being provided with a server communicably connected with first terminals provided at said manufacturers and second terminals provided in said stores, said server provided with entry means enabling input of product information of said products from said first terminals, product information display means for sending said product information to and displaying it at said second terminals, and acquiring means for acquiring histories by which said product information is accessed by said second terminals.

In such a product purchasing trend analyzing system, said system is provided with a customer purchasing trend database for storing information giving a first history as to what products' product information said customers access, a second history as to which products said customers have purchased, and a third history as to which items among a plurality of items showing specifications of said products said customers access, and said server counts the number of times customers access predetermined product categories in said product information in product category units, stores the counted values in said customer purchasing trend database, reads from said customer purchasing trend database if said customers have purchased products and reads what items among the plurality of items showing specifications of said products said customers accessed, and displays purchasing trends of products so as to analyze the reasons why said customers selected the manufacturers whose products said customers have purchased, from among a plurality of manufacturers providing product information of said products which said customers access, by provision of first display means.

In such a product purchasing trend analyzing system, said system is provided with a customer purchasing trend database for storing information giving a first history as to what products' product information said customers access, a second history as to which products said customers have purchased, and a third history as to which items among a plurality of items showing specifications of said products said customers access, and said server counts the number of times customers access predetermined product categories in said product information in product category units, stores the counted values in said customer purchasing trend database, reads from said customer purchasing trend database if said customers have purchased products of said product category, and displays a list comparing for each product category the manufacturers for which customers view said product categories or purchase from, from among a plurality of manufacturers providing product information of products of said product categories accessed by said customers, by provision of second display means.

In such a product purchasing trend analyzing system, said system is provided with a customer purchasing trend database for storing information giving a first history as to what products' product information said customers access, a second history as to which products said customers have purchased, and a third history as to which items among a plurality of items showing specifications of said products said customers access, and said server counts the number of times customers access predetermined product categories in said product information in product category units, stores the counted values in said customer purchasing trend database, reads from said customer purchasing trend database if said customers have purchased products of said product categories and reads which items among a plurality of items showing specifications of said products said customers have accessed, and displays a list comparing, for each product category, the number of times said customers have accessed a plurality of items showing specifications of said products of manufacturers compared with a specific manufacturer among a plurality of manufacturers providing product information of products of said product category which said customer accesses with said specific manufacturer for each manufacturer by provision of a third display means.

In such a product purchasing trend analyzing system, the system is provided with a second server separate from said server provided with said acquiring means, and said second server stores information giving a first history as to what products' product information said customers access, a second history as to which products said customers have purchased, and a third history as to which items among a plurality of items showing specifications of said products said customers access and sets the restocking quantities and prices of the products.

### BRIEF DESCRIPTION OF DRAWINGS

FIG. 1 is a schematic view of the configuration of a product purchasing trend analyzing system according to a first embodiment of the present invention.

FIG. 2 is a view of a specific example of data stored in a product information database.

FIG. 3A is a view of a specific example of a screen for registering product information before registration.

FIG. 38 is a view of a specific example of a screen for registering product information after registration.

FIG. 4A is a view of a specific example of a screen for inputting detailed product information before input.

FIG. 4B is a view of a specific example of a screen for inputting detailed product information after input.

FIG. 5 is a view of a specific example of data stored in a product information update history database.

FIG. 6 is a view of an example of the specific arrangement of advertisement banners on a display screen.

FIG. 7 is a flow chart of a procedure of a routine for recording an update history of product information in a product information update history database.

FIG. 8A is a view of a procedure (1) for a customer to acquire product information through a display screen of an information terminal.

FIG. 8B is a view of a procedure (2) for a customer to acquire product information through a display screen of an information terminal.

FIG. 8C is a view of a procedure (3) for a customer to acquire product information through a display screen of an information terminal.

FIG. 9A is a view of a procedure (1) for a customer to acquire detailed information relating to products of a first manufacturer through a display screen of an information terminal.

FIG. 9B is a view of a procedure (2) for a customer to acquire detailed information relating to products of a first manufacturer through a display screen of an information terminal.

FIG. 9C is a view of a procedure (3) for a customer to acquire detailed information relating to products of a first manufacturer through a display screen of an information terminal.

FIG. 9D is a view of a procedure (4) for a customer to acquire detailed information relating to products of a first manufacturer through a display screen of an information terminal.

FIG. 10A is a view of a procedure (1) for a customer to acquire detailed information relating to products of a second manufacturer through a display screen of an information terminal.

FIG. 10B is a view of a procedure (2) for a customer to acquire detailed information relating to products of a second manufacturer through a display screen of an information terminal.

FIG. 10C is a view of a procedure (3) for a customer to acquire detailed information relating to products of a second manufacturer through a display screen of an information terminal.

FIG. 11 is a view of a specific example of comparison information of the same products of a first manufacturer and second manufacturer displayed on a display screen of an information terminal.

FIG. 12A is a view of a specific example of data stored in a customer purchasing trend database and shows history information in the case where a customer acquires product information, but does not purchase a product.

FIG. 12B is a view of a specific example of data stored in a customer purchasing trend database and shows history information in the case where a customer acquires product information and views one item of the detailed information, but does not purchase a product.

FIG. 12C is a view of a specific example of data stored in a customer purchasing trend database and shows history information in the case where a customer acquires product information and views one item of the detailed information, but does not purchase a product.

FIG. 12D is a view of a specific example of data stored in a customer purchasing information database and shows history information in the case where a customer acquires product information and purchases a product.

FIG. 13 is a flow chart of a procedure for preparing a customer purchasing trend database.

FIG. 14A is a view of a specific example of a database of analysis results stored in a customer purchasing trend database and shows analysis results in customer units.

FIG. 14B is a view of a specific example of a database of analysis results stored in a customer purchasing trend database and shows analysis results in product category units.

FIG. 14C is a view of a specific example of a database of analysis results stored in a customer purchasing trend database and shows analysis results of manufacturer comparison information.

FIG. 15A is a view of a table of the number of times of viewing and the number of purchases for a predetermined category in a certain period (for example, one month) for forecasting a restocking quantity of products.

FIG. 15B is a view of a table of the number of times of viewing for a predetermined category in a certain period (for example, one month).

FIG. 16A is a view of a table of the number of days from a predetermined viewing day of a predetermined product (for example Saturday) to a purchasing day in a certain period (for example, one month) for every day of viewing days for forecasting the restocking date of products.

FIG. 16B is a view of a table of the number of days from a viewing day to a purchasing day in a recent certain period (for example, one week).

### BEST MODE FOR CARRYING OUT THE INVENTION

Below, embodiments of the present invention will be explained in detail with reference to the attached drawings.

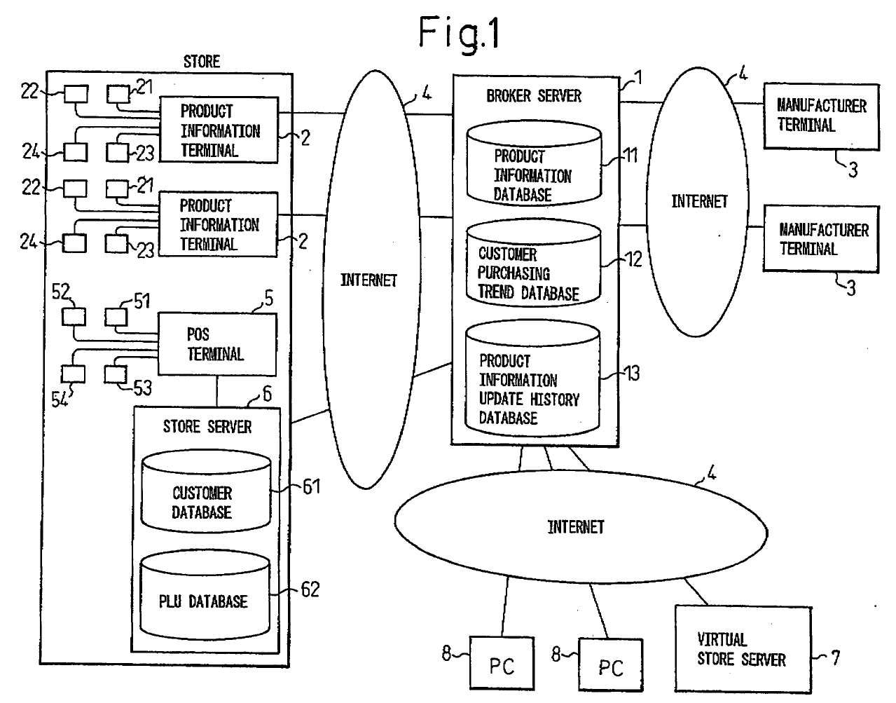

FIG. 1 is a schematic view of the configuration of a product purchasing trend analyzing system according to a first embodiment of the present invention. The system shown in FIG. 1 has a broker server (hereinafter simply referred to as a “main server”) 1, product information terminals (hereinafter simply referred to as “information terminals”) 2, and manufacturer terminals 3. These are normally arranged far away from each other and are connected in a communicable manner through the Internet or another communication network (hereinafter referred to as a “network”).

The main server 1 is arranged in the building of a broker and is a general medium- or large-sized computer system. An auxiliary disk stores a product information database DB 11, a product information update history database DB 12, and a customer purchasing trend database DB 13. These databases will be explained in detail later.

The information terminals 2 are also called clients or customers, are arranged in stores for retailing products, and can provide information to customers without the help of store clerks. A display 21, card reader 22, bar code reader 23, and printer 24 are connected to each. The information terminals 2 provide product information to be sent to the customers from the main server 1 through the monitor screens of the displays 21. Due to this, it is possible to save the time of store clerk in explaining products in the stores. Further, the history data of input operations by customers from touch panels or the mouses etc. provided at the information terminals 2 is stored in the client purchasing trend database DB in the main server 1. The card readers 22 read registration numbers unambiguously specifying customers stored in for example magnetic cards or IC cards. These cards are also utilized as bonus point cards. “Bonus point cards” record the number of bonus points which customers acquire in accordance with the amounts which the customers purchase. The customers receive benefits such as discounts the next time they purchase from stores in accordance with the number of bonus points.

The bar code readers 23 read bar codes specifying products and carrying information on the products which customers desire to have displayed on the monitor screens of the displays 21. Bar codes generally include “JAN-8” and “JAN-13” bar codes based on the JAN (Japanese Article Numbering), “EAN-8” and “EAN-13” bar codes based on the EAN (European Article Numbering), and “UPC/A” and “UPC/E” bar codes based on the UPC (Universal Product Code). When products are large or heavy, printed matter bearing the bar codes are prepared separately and utilized by the customers.

The printers 24 are provided for customers or store clerks to print out printable information displayed on monitor screens of displays 21 on paper for memo use.

The manufacturer terminals 3 are arranged in the buildings of manufacturers. By writing product information relating to the specifications, price, etc. of products in a predetermined format provided at the main server 1 side, the product information is sent to the main server 1 and is stored in the product information database DB 11 at the main server 1. Further, when preparing or updating the product information database DB 11 at the main server 1, the numbers of registered bonus points of the products and the numbers of times of registration input from the manufacturers are stored in the product information update history database DB (hereinafter simply referred to as the “update history database DB”) 12.

Stores are provided with POS terminals 5 at their cash registers. Further, each POS terminal 5 has a display 51, card reader 52, bar code reader 53, and printer 54 connected to it. Store clerks read the bar codes attached to products by bar code readers provided at the POS terminals 5 when products are purchased.

Stores or headquarters of stores (normally having a plurality of stores) located away from the stores are provided with store servers 6 communicably connected to the POS terminals 5. Each store server 6 stores in an auxiliary disk a customer database DB 61 and PLU (Price Look Up) database DB 62. The store servers 6 are connected communicably with the main server 1 and update the prices of products in the product information database. The customer DB's 61 and PLU DB's 62 store information relating to products purchased by customers input by store clerks through bar code readers 53, specifically, tables of correspondence among the bar codes, product names, and prices. The information stored in the customer DB's 61 are transferred through the network 4 to the customer purchasing trend DB 12 in the main server 1. The PLU DB 62's contain information used only for processing in stores.

Further, a virtual store server 7 provided in the building of a virtual store is communicably connected to the main server 1 through the network 4. Customers registered at the virtual store through personal computers (PC) 8 of the customers connected communicably to the main server 1 through the Internet 4 can shop through the Internet without going out to actual stores and using information terminals 2 at the stores. The virtual store server 7 has similar functions to a store server 5.

The first embodiment shown in FIG. 1 has customers operate the product information terminals and tries to obtain the operation history, but even if giving mobile terminals carried by store clerks the same functions as product information terminals and enabling the store clerks to operate items of the latest information of products which customers ask the store clerks about or items instructing the store clerks to view detailed information of products, effects the same as those of the first embodiment are obtained.

Next, the preparation and updating of the product information database DB 11 will be explained.

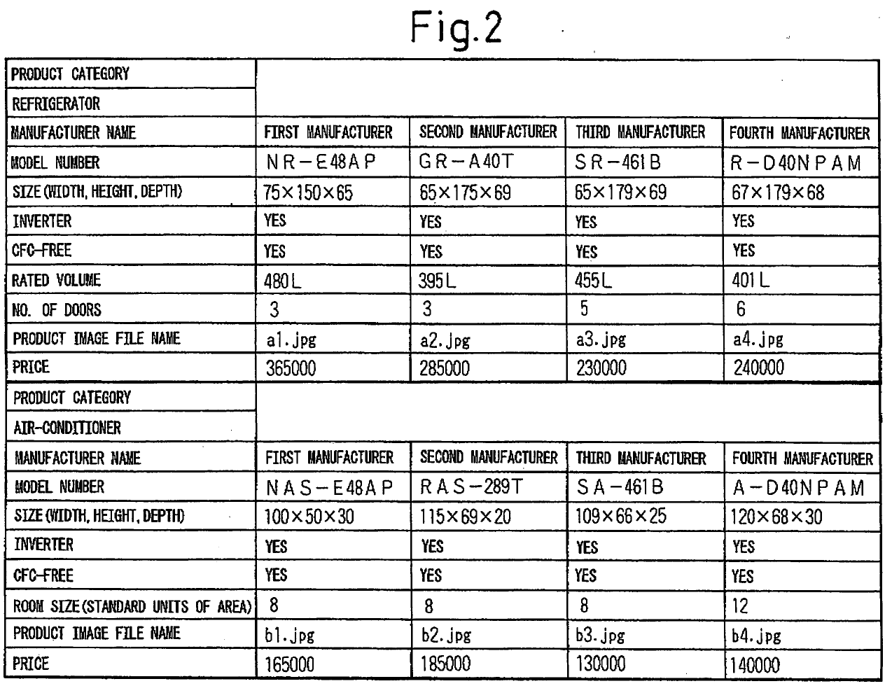

FIG. 2 is a view of a specific example of data stored in the product information database. The main server 1 connected to the network 4 has a product information entry means and prepares a product information database such as shown in FIG. 2 based on the information entered from manufacturer terminals 3. The “product information entry means” indicates a means for the main server 1 to prepare or update its product information database by displaying an input format screen (product information registration screen) on display screens of displays of manufacturer terminals 1 and having the manufacturer sides input information on the screens when the manufacturers register product information. This input format is prepared so as to enable customers to easily compare specifications of products among competing manufacturers.

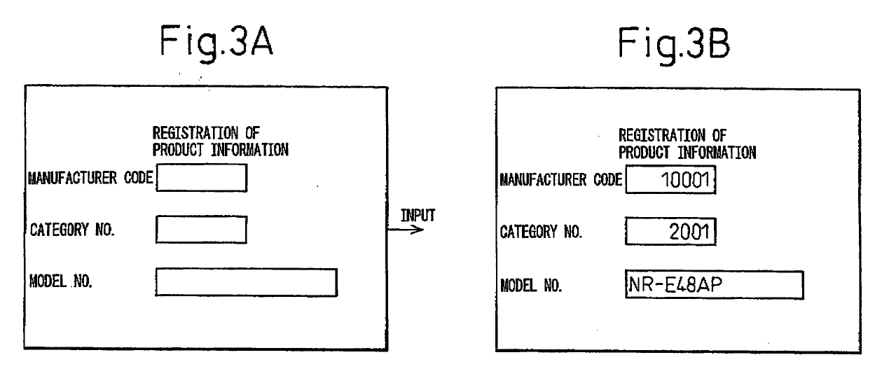

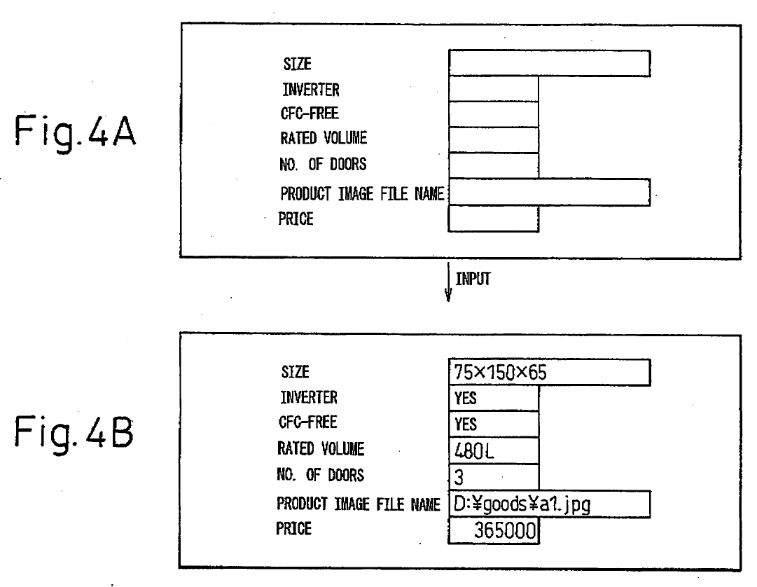

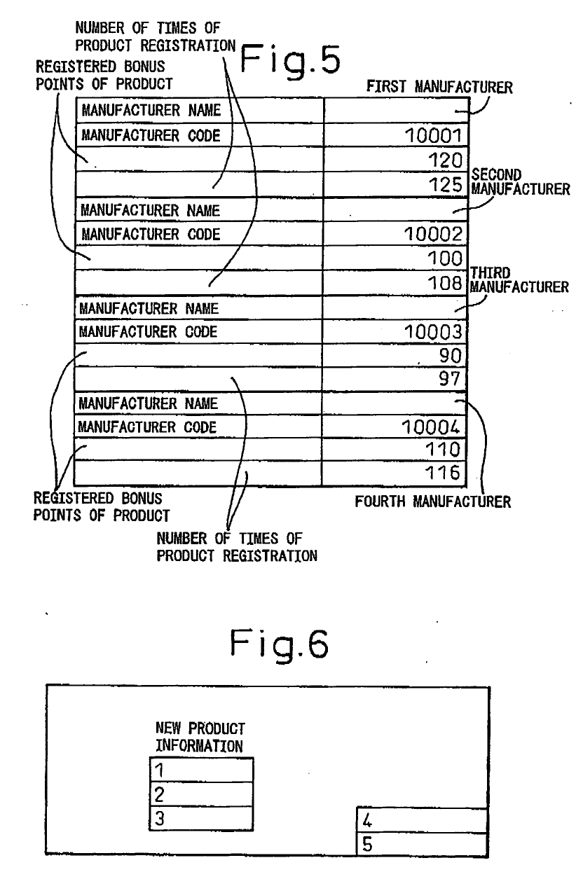

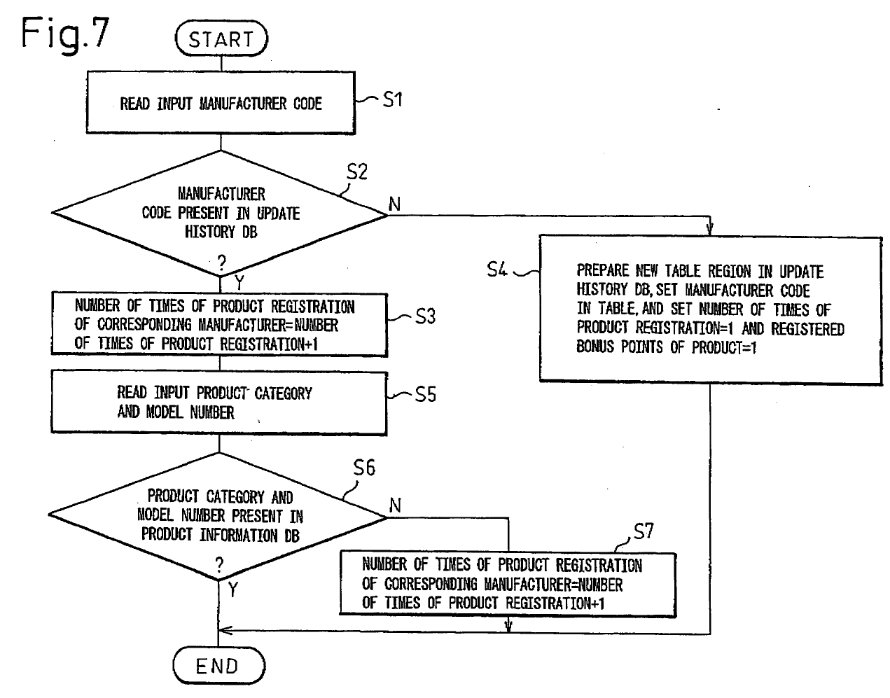

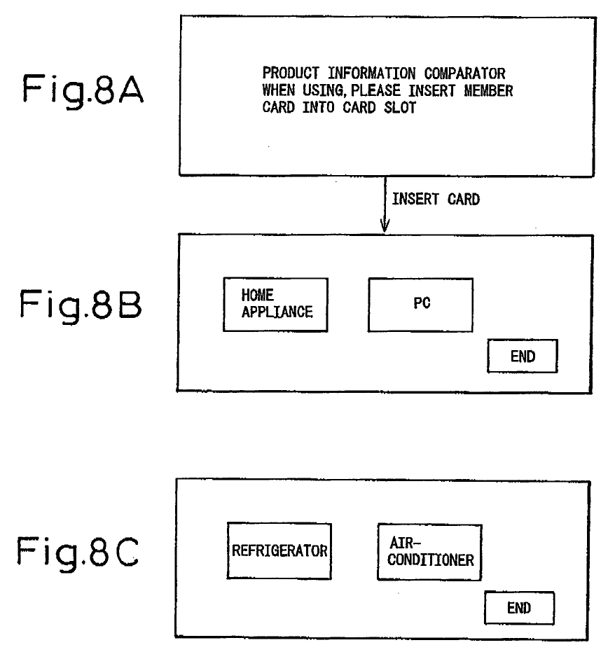

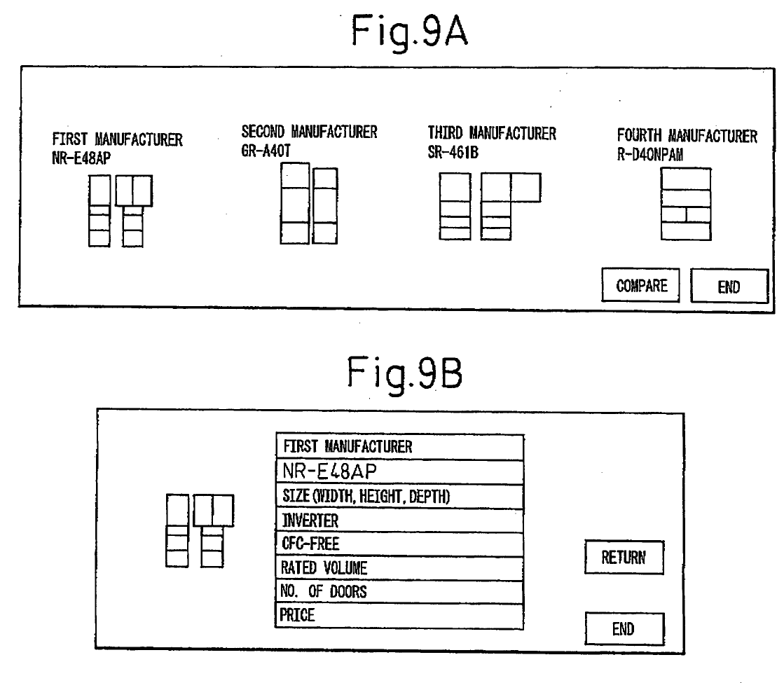

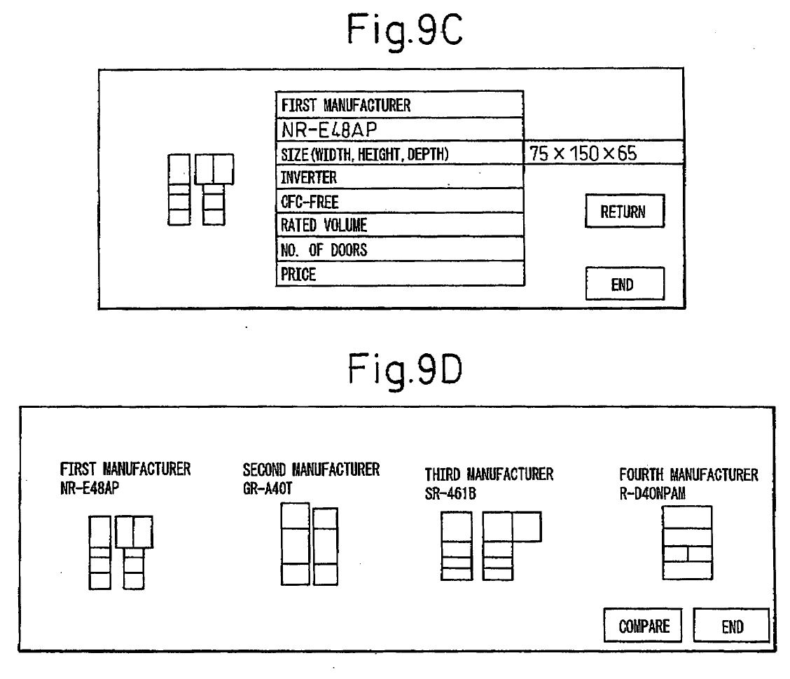

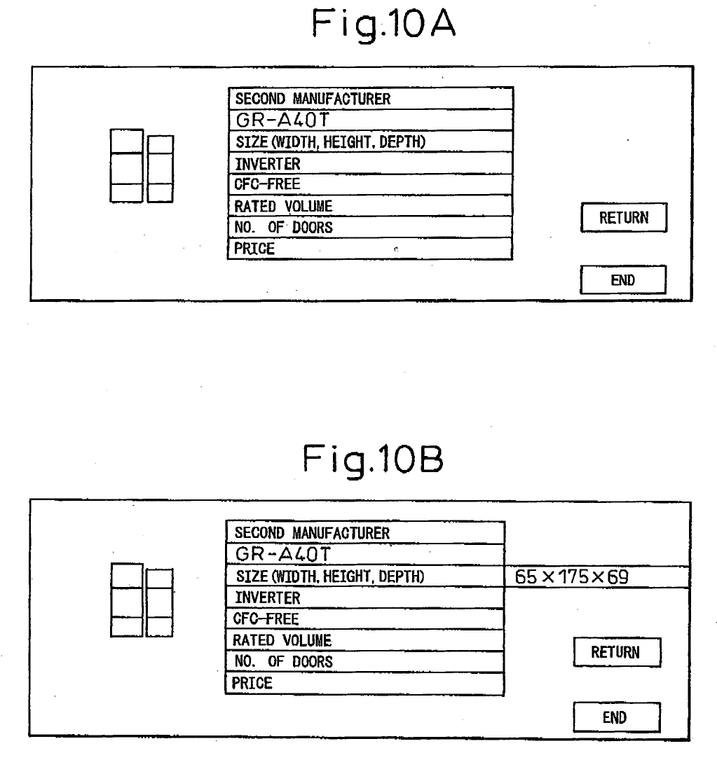

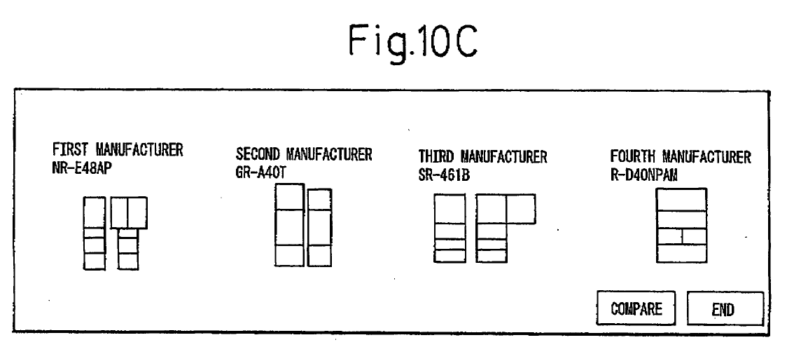

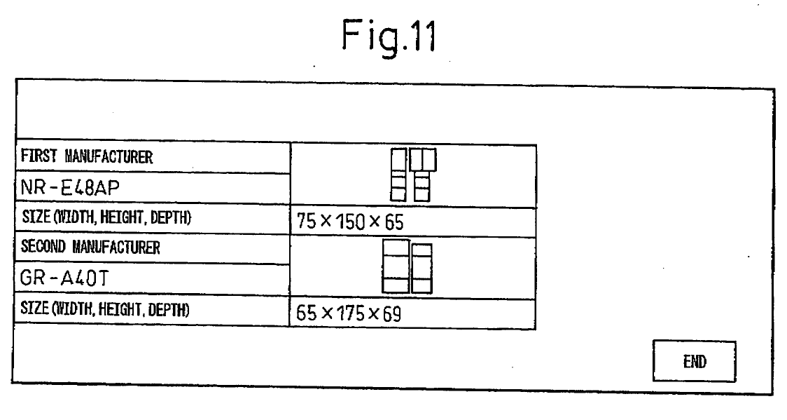

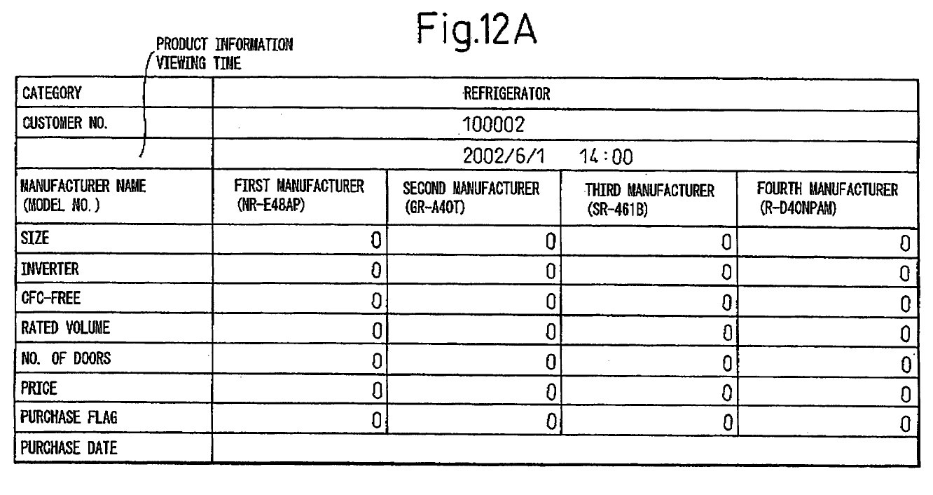

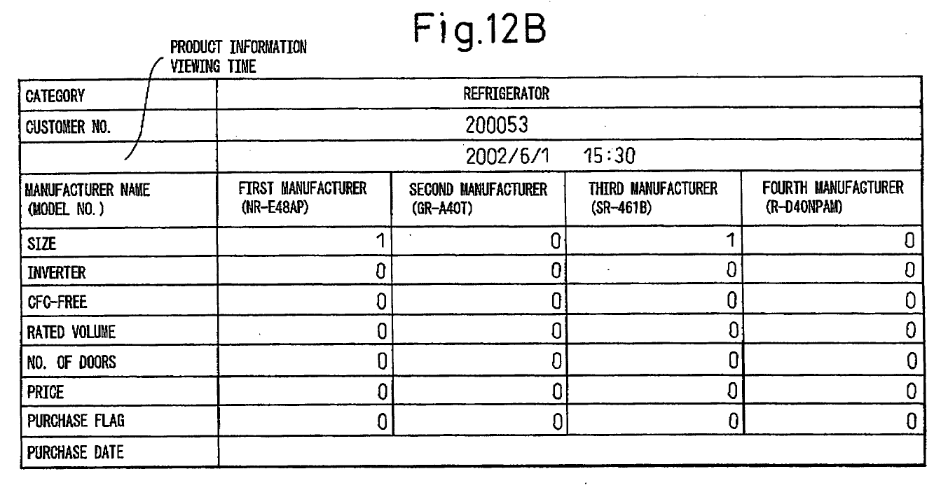

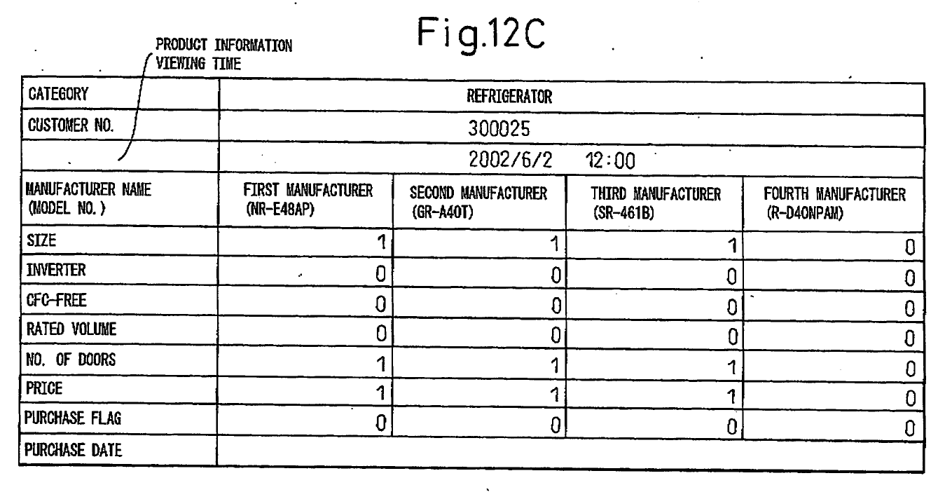

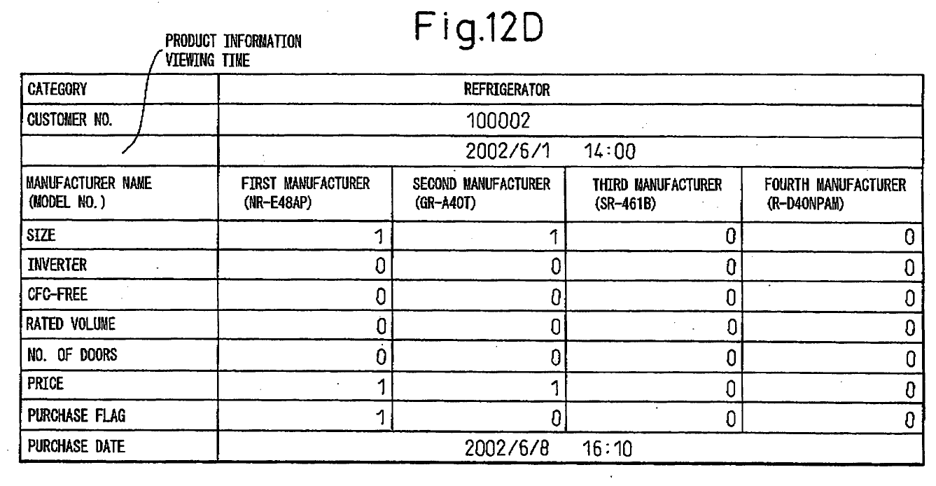

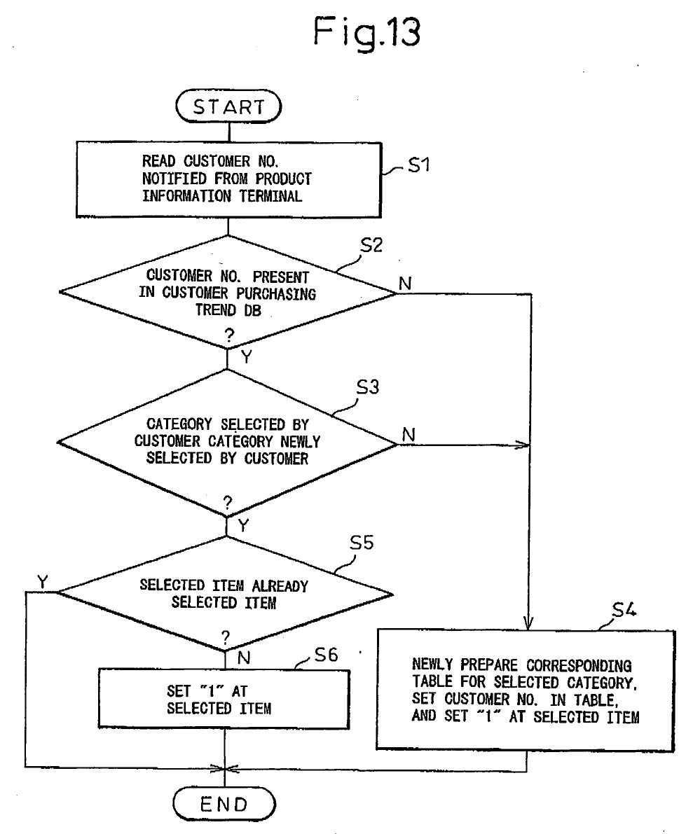

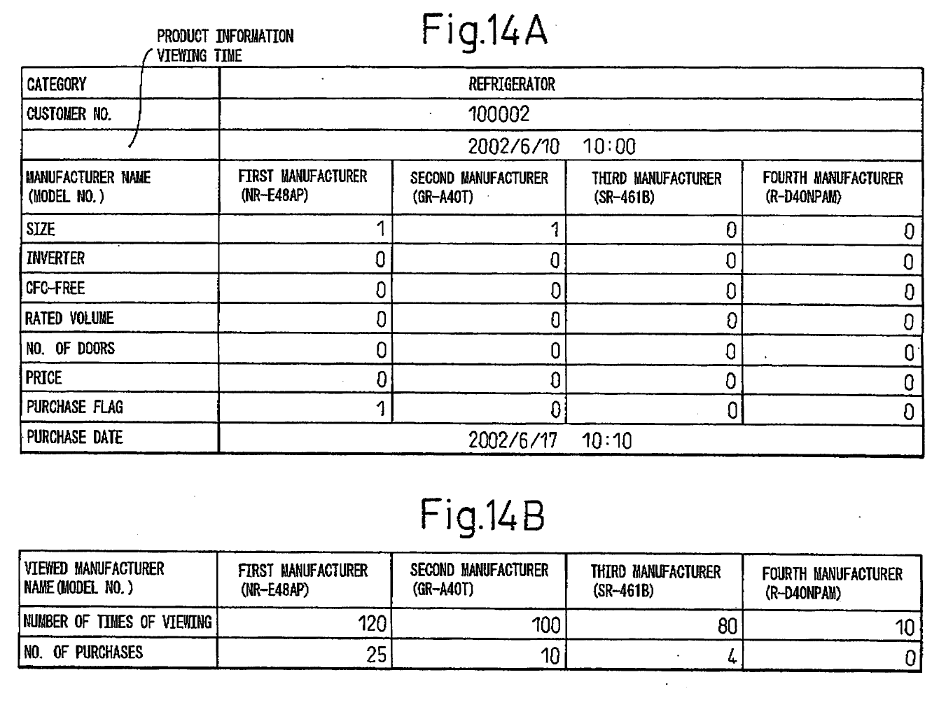

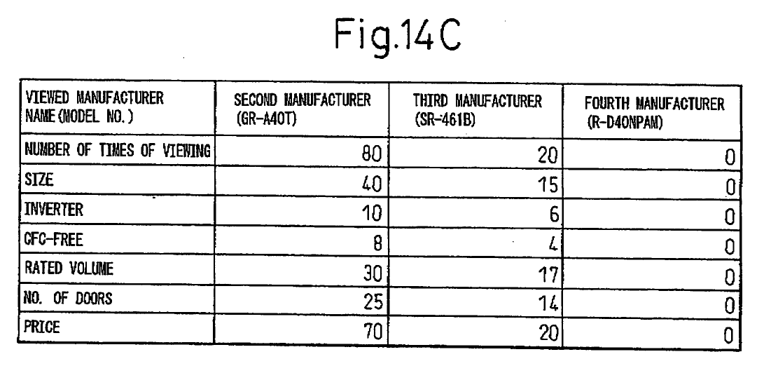

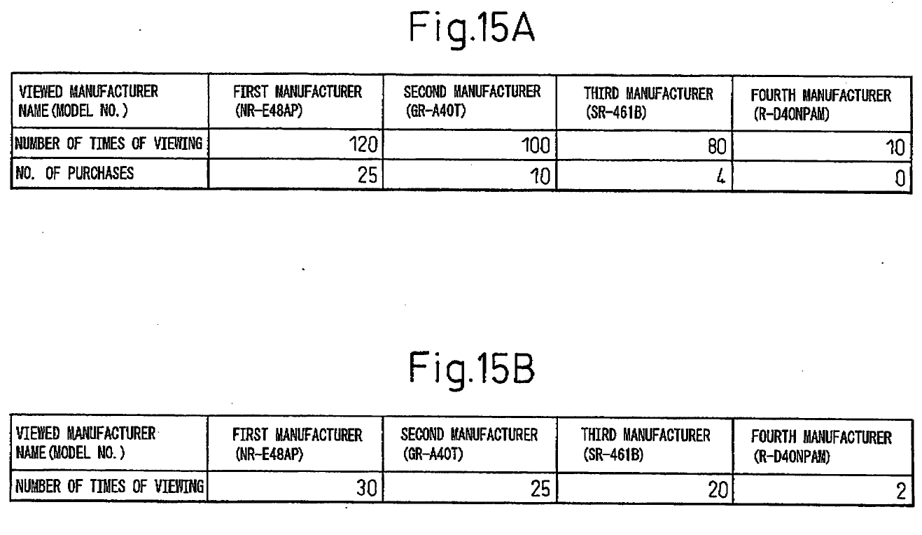

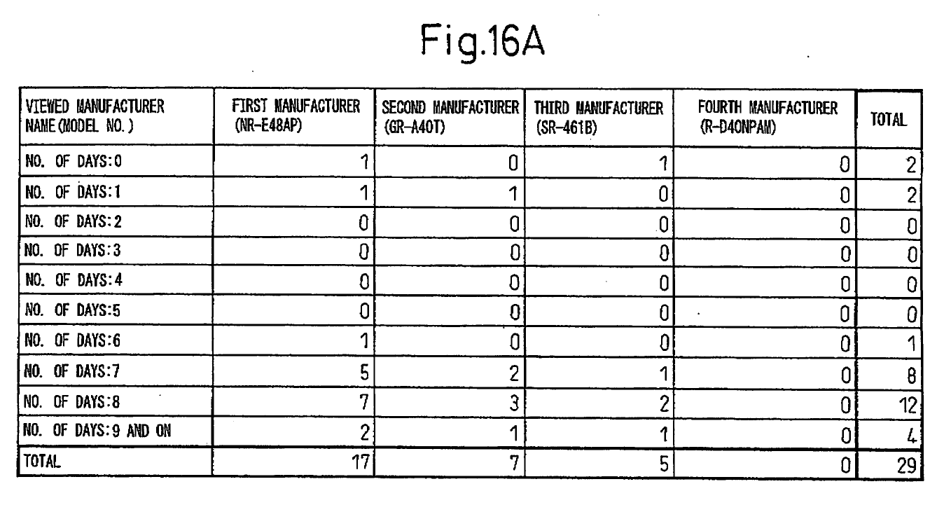

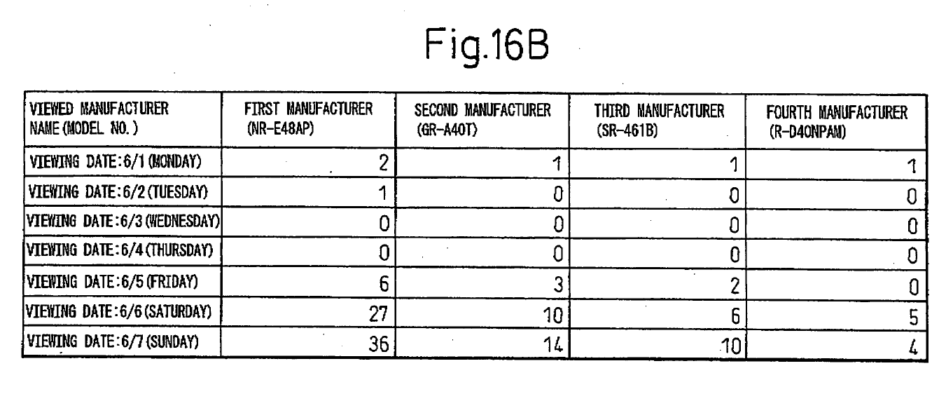

FIG. 3A and FIG. 3B are views of specific examples of a screen for registering product information, where FIG. 3A is a view of a screen before registration and FIG. 3B is a view of a specific example of a screen after registration. As shown in FIGS. 3A and 3B, the product information registration screen shows input entry fields for the manufacturer code, category number, and model number. Information is input into the fields using a keyboard so as to register the product information. The manufacturer code “10001” shown in FIG. 3B shows a first manufacturer, the category number “2001” shows a refrigerator, and the model number “NR-E48AP” shows the model number of the refrigerator. After finishing inputting information on the product information registration screen, if using a mouse to click on or using a touch pen to touch (hereinafter referred to simply as “click”) the category number “2001” or the model number “NR-E48AP”, a screen for inputting detailed information of the product, that is, FIG. 4A, is displayed on the screen.

FIG. 4A and FIG. 4B are views of specific examples of a screen for inputting detailed product information. FIG. 4A is a view of a screen before input, while FIG. 4B is a view of a screen after input. In the examples shown in FIGS. 4A and 4B, information on the items of the specifications of a refrigerator of the model number “NR-E48AP”, that is, the size, inverter, CFC-free state, rated volume, number of doors, the product image file name, and price can be input. The price can be set for each store. Further, it is possible to provide a remarks field as an item of the specification and provide an explanation of the method of use of the product etc.

When each manufacturer finishes registering product information as shown in FIGS. 3A and 3B and FIGS. 4A and 4B, the server 1 prepares the product information database for the refrigerators as shown in FIG. 2 and displays it upon request on the screens of information terminals 2 or personal computers 8.

Next, preparation of the product information update history database DB 13 will be explained.

FIG. 5 is a view of a specific example of data stored in the product information update history database. When preparing the product information database, manufacturers register product information in the main server 1. The main server 1 judges the degrees of contribution of the manufacturers to the main server 1 by the numbers of registrations or numbers of registered bonus points of the product information and gives incentives to the manufacturers in accordance with the degrees of contribution in this system. As one example of these incentives, the display positions of banners of advertisement information of new products on the screens of the information terminals 2 or PC's 8 are set to more conspicuous positions the higher the degrees of contributions of the manufacturers.

FIG. 6 is a view of an example of the specific arrangement of advertisement banners on a display screen. As shown in the screen shown in FIG. 6, the advertisement banners of new product information are for example displayed at conspicuous positions 1 to 5 in the order of the greatest number of registered bonus points of products or the order of the greatest number of registered bonus points of products+number of times of product registration.

FIG. 7 is a flow chart of a procedure of a routine for recording an update history of product information in a product information update history database. The numbers following the “S”'s in the flow chart of FIG. 7 show the step numbers. First, at step S1, the manufacturer code input from a manufacturer terminal is read. At step S2, it is judged if the read manufacturer code is present in the update history database. When the result of judgment is YES, the routine proceeds to step S3, while when NO, the routine proceeds to step S4. At step S3, the number of times of product registration+1 of the manufacturer is calculated for updating. At step S4, a new table region is prepared on the update history database, the manufacturer code is set in the table, and the number of times of product registration=1 and the number of registered bonus points of products=1 are set. At step S5, the category and the model number of the product input are read. At step S6, it is judged if the category and model number of the product read at step S5 are present in the product information database. When the result of judgment is YES, the routine is ended, while when NO, the routine proceeds to step S7.

As explained above, the update history database can be used for measurement of the degree of contribution of registration of product information from manufacturers to stores. In the first embodiment, the update history database DB 13 is sent to store servers 6 installed in stores. Store servers 6 receiving this sent data can automatically determine the restocking quantities of products by the stores in accordance with the degrees of contribution of registration of product information from manufacturers to the stores.

In the above first embodiment, the example is shown of the update history database DB 13 installed in the main server 1, that is, the server of a broker, but it is also possible to have the role of the broker handled by the stores as an embodiment. In such a second embodiment, the auxiliary disks of the store servers 6 installed in the stores store product information databases DB 11, product information update history databases DB 12, and customer purchasing trend databases DB 13. Using the data of the update history databases DB 12, in the same way as explained using FIG. 6, the positions of the advertisement banners of new product information of manufacturers on the display screens of the information terminals are determined in accordance with the degrees of contribution of registration of product information from the manufacturers to the stores. Further, it is also possible to configure the system so as to automatically determine the restocking quantities of products by stores in accordance with the degrees of contribution of registration of product information from the manufacturers to the stores.

Next, the process of a customer acquiring product information to purchasing a product and the process of analyzing purchasing trends of products from the history will be explained below.

FIG. 8A to FIG. 8C are views of a procedure for a customer to acquire product information through a display screen of an information terminal, wherein FIG. 8A is a view of an information screen, FIG. 8B is a view of a product selection screen, and FIG. 8C is a view of a product category selection screen. The customer registers as a member at the store and is issued a recording medium including customer-specific information, that is, a customer card, from the store. Due to the product information display means of the main server 1, the product information display means information terminal normally displays the information screen shown in FIG. 8A. As the customer card, a magnetic card or IC card etc. is used. When the customer card is inserted into the card slot, the customer card is read by the scanner of the information terminal, the display screen of the information terminal displays a product selection screen shown in FIG. 8B, and simultaneously a customer no. specific to the customer is read. Next, when the product is selected, a product category selection screen shown in FIG. 8C is displayed. When “refrigerator” is clicked on the product category selection screen shown in FIG. 8C, as shown in FIG. 9A, images of products of manufacturers belonging to the selected product category “refrigerators” (hereinafter simply referred to as “icons”) are displayed on the screen.

Note that a customer can also view the screen of an information terminal without a customer card, but in this case the history of what specifications a customer actually purchasing a product showed interest in when deciding to purchase the product cannot be obtained.

FIG. 9A to FIG. 9D are views of a procedure for a customer to acquire detailed information relating to a product of a first manufacturer through a display screen of an information terminal, where FIG. 9A is a view of a screen showing icons of a plurality of manufacturers of a selected product, FIG. 9B is a view of a screen showing a product description of a manufacturer of a selected product, FIG. 9C is a view of more detailed description of the product description of FIG. 9B, and FIG. 9D is a view of a screen displayed when clicking on “return” on the screen of FIG. 9C. In FIG. 9A, the product information database is viewed to display manufacturer names, model numbers, and product images. If clicking on the icon of the first manufacturer at FIG. 9A, as shown in FIG. 9B, the product description item information is displayed. At this time, the type of the selected icon (product name of purchase candidate) is saved in the memory of the information terminal 2.

In FIG. 9B, if clicking on “size (width, height, depth)” in the product description items, the detailed data “size (width, height, depth) 75×150×65” of the “size (width, height, depth)” is displayed as shown in FIG. 9C. At this time, the selected item is saved in the memory of the information terminal 2.

When clicking on product description item information in this way, detailed information relating to the item is displayed. At this time, the selected item (purchase perspective of product) is saved in the memory.

FIG. 10A to FIG. 10D are views of a procedure for a customer to acquire detailed information relating to a product of a second manufacturer through a display screen of an information terminal, where FIG. 10A is a view of a screen showing a product description of a selected manufacturer of a selected product, FIG. 10B is a view of a more detailed description of the product description of FIG. 10A, and FIG. 10C is a view of a screen displayed when clicking on “return” on the screen of FIG. 10B. FIG. 10A to FIG. 10C correspond to FIG. 9B to FIG. 9D.

Further, as shown in FIGS. 12A to 12D, when viewing product information, the time when a customer views product information and the time when it purchases a product are also acquired.

Therefore, the customer purchasing trend DB is provided with the following items:

1. Time when customer views product information at product information terminal (time of viewing of product information)

2. Time when customer purchases product (time of purchase)

The time of purchase is set when “1” is set for the purchase flag.

FIG. 11 is a view of a specific example of comparison information of the same product of a first manufacturer and second manufacturer displayed on a display screen of an information terminal. When “compare” is clicked on the screen shown in FIG. 10C, the comparison data display means displays a selected item comparison screen enabling comparison of specification items relating to the “refrigerator” of the selected manufacturers as shown in FIG. 11.

Next, the preparation of the customer purchasing trend database DB 12 will be explained.

As explained above, when a customer finishes viewing products, the viewed information is sent from the information terminal 2 to the main server 1 and the selected products (names of products of purchase candidates) and selected items (purchasing perspectives of products) are saved in the customer purchasing trend database 12 in the main server 1. Below, the processing for preparing this customer purchasing trend database will be explained.

FIG. 12A to FIG. 12D are views of specific examples of data stored in the customer purchasing trend database, wherein FIG. 12A shows history information in the case where a customer acquires product information, but does not purchase a product, FIG. 12B shows history information in the case where a customer acquires product information and views one item of the detailed information, but does not purchase a product, FIG. 12C shows history information in the case where a customer acquires product information and views one item of the detailed information, but does not purchase a product, and FIG. 12D shows history information in the case where a customer acquires product information and purchases a product. FIG. 12D shows an example by which the main server 1 is notified of purchasing information from POS terminal 5 when a customer purchases model number NR-E48AP of the first manufacturer.

In FIGS. 12, items indicated as “1” show items which the customer views among the detailed information of the products, while ones indicated as “0” show items not viewed.

As explained above, the customer purchasing trend database DB is a collection of data on the viewed items which a customer selects at the information terminal 2 recorded in category units or for each customer.

FIG. 13 is a flow chart of a procedure for preparing the customer purchasing trend database. There are the following two cases of preparation of a customer purchasing trend database by acquiring means of the present invention.

(1) When a customer views a product, the information terminal 2 reads a recording medium (member card) including information unique to the customer, the information terminal 2 notifies the purchasing information to the main server 1, and the purchasing information is saved in the customer purchasing trend database 12.

(2) When a customer purchases a product, the POS terminal 5 reads a recording medium (member card) including information unique to the customer, the POS terminal 5 notifies the purchasing information to the main server 1, and the purchasing information is saved in the customer purchasing trend database 12.

At step S1 of FIG. 13, the customer number notified from the information terminal 2 is read. At step S2, it is judged if the customer number read at step S1 is present in the customer purchasing trend database. When the result of judgment is YES, the routine proceeds to step S3, while when NO, the routine proceeds to step S4.

At step S3, it is judged if the category which the customer selects was newly selected by the customer. When the result of judgment is YES, the routine proceeds to step S5, while when NO, the routine proceeds to step S4.

At step S4, the selected category is judged, a new table corresponding to that category is prepared, the customer number is set in the table, and “1” is set in the selected item.

At step S5, the already selected table is viewed to judge if the selected item is an already selected item. When the result of judgment is YES, the routine ends, while when NO, the routine proceeds to step S6. At step S6, “1” is set in the selected item.

The main server 1 has a customer selection information counting means, has customer unit information extracting means, category unit information editing means, and comparative manufacturer information editing means, edits the information, displays the results on the screen, or prints them out on the paper.

FIG. 14A to FIG. 14C are views of specific examples of a database of analysis results stored in a customer purchasing trend database, wherein FIG. 14A and shows analysis results in customer units, FIG. 14B shows analysis results in product category units, and FIG. 14C shows analysis results of manufacturer comparison information. In the example shown in FIG. 14A, information of customer number 100002 is extracted and it is judged if the customer has selected the first manufacturer by comparison of the size of the first manufacturer and second manufacturer.

FIG. 14B shows an example of counting information in customer units in analysis of category units. The number of times of viewing and the number of purchases are shown. It is judged that a fourth manufacturer was viewed, but was not purchased from.

FIG. 14C shows an example of analysis of comparison information of manufacturers and shows the counting of manufacturers compared with the first manufacturer. It is judged that the first manufacturer and second manufacturer are competing. Further, it is judged that the purchasing conditions are viewed in the order of price, size, and rated volume. For example, it is possible to use the price and size as materials for judgment of the purchasing conditions and, when low priced and small sized products are purchased, judge that there is such demand. If providing this information to manufacturers, this can help product development of the manufacturers.

Next, the method of forecasting restocking quantities and restocking dates for products based on the customer purchasing trend DB will be explained.

By acquiring the product information viewing times of customers and the histories of viewing times, it is learned how many days after viewing the product information the individual customers purchased products. By obtaining statistics on the numbers of times of viewing of individual products and how many days after viewing the product information the products were purchased, stores can forecast the restocking quantities and restocking dates of individual products.

FIG. 15A is a view of a table of the number of times of viewing and the number of purchases for a predetermined category in a certain period (for example, one month) for forecasting the restocking quantities of products. FIG. 15B is a view of a table of the number of times of viewing for a predetermined category in a certain period (for example, one month).

From the information shown in FIG. 15A, for example, it is learned that 25 of the refrigerators of the first manufacturer (NR-E48AP) were sold by 120 viewings. That is, it is learned that products were purchased at a rate of 25÷120≈0.20 for the number of times of viewing.

From the results shown in FIG. 15B, if forecasting the restocking quantity for the next week for refrigerators of the first manufacturer (NR-E48AP),
Restocking quantity=30×0.20=6 units
is forecasted.

Similarly, if forecasting the restocking quantity for the next week for refrigerators of the second manufacturer (GR-A40T),
Restocking quantity=25×0.10≈3 units
is forecasted.

FIG. 16A is a view of a table counting the numbers of days from predetermined viewing days of predetermined products (for example Saturday) to purchasing days in a certain period (for example, one month) for every day of viewing days for forecasting the numbers of purchases of products. FIG. 16B is a view of a table of the numbers of days from viewing days to purchasing days for a predetermined category in a recent certain period (for example, one week).

From the information shown in FIG. 16A, it is learned that the refrigerators of the first manufacturer (NR-E48AP) are often purchased seven days to eight days after viewing when the viewing date is a Saturday.

From the result shown in FIG. 16B, it is forecasted that there will be demand seven days later on June 13 (Saturday) and eight days later on June 14 (Sunday) starting from the viewing date June 6 (Saturday) and it is learned that inventory should be restocked for that.

The restocking quantity is forecasted as follows:

Therefore, the ratio of a person viewing a refrigerator of the first manufacturer (NR-E48AP) on a Saturday purchasing it after seven days is 5÷17≈0.30 and the ratio of it purchasing it after eight days is 7÷17≈0.40.

The number of times of viewing on June 6 (Saturday) in the most recent one week is 27, so using the above method of forecasting restocking, 27×0.20≈5.4≈6 units.

Therefore, the forecast of demand for June 13 (Saturday) after seven days is 6 (units)×0.30≈1.8≈2 (units), while the forecast of demand for June 13 (Saturday) after eight days is 6 (units)×0.40≈2.4≈3 (units).

As explained above, by acquiring the history of the viewing times of product information and the purchasing times of customers, it is learned how many days after viewing product information individual customers purchased products. By obtaining statistics on the number of times of viewing of individual products and how many days after viewing product information what products were purchased, stores can forecast the restocking quantity and restocking dates of individual products.

The restocking quantity is forecasted by the ratio of the number of times of viewing and number purchased of individual products. Further, the restocking dates may be forecasted by the method of obtaining statistics on how many days after viewing products were purchased so as to set the restocking dates after the periods of the peak values.

According to the product purchasing trend analyzing system according to the present invention explained above, stores and manufacturers can obtain the following advantages:

(i) Advantages to Stores
It is possible to analyze in real time what products each customer considered as purchase candidates or from what perspectives it purchased products, so it is possible to propose products specifically targeted to each customer and possible to promote sales. Since it is possible to analyze which products were considered as purchase candidates or from which perspectives customers purchased products from the counted results stored in the product information update history database, it is possible to suitably judge in real time the restocking quantity and pricing of products as purchase candidates.
It is possible to judge products considered as purchase candidates or products not considered as purchase candidates from the counted results, so it becomes easy to restock products and formulate price strategies.
Customers can display on screens comparisons of items of specifications of competing manufacturers for the same products and therefore are freed of trouble in comparing products.
Customers can use terminals in stores to learn of product information, so staff explaining products in stores can cut the time taken for product descriptions and can concentrate on their main jobs and in turn work efficiency of staff can be improved.

(ii) Advantages to Manufacturers
Even if not collecting questionnaires regarding purchased products from customers purchasing products, it is possible to judge which products compete with which manufacturers and from what perspectives customers specifically compare and consider what specifications of products with other manufacturers for purchase of products and possible to obtain product development information in real time so as to enable product development along with constantly changing consumer trends.
Further, it is possible to advertise manufacturers or new products at conspicuous positions on display screens of product information terminals in stores in accordance with the number of times of registrations or number of registered bonus points of product information from manufacturers to the system.

(Appendix 1)

A product purchasing trend analyzing system for analyzing purchasing trends of products which manufacturers sell in stores,

said product purchasing trend analyzing system characterized by being provided with a server communicably connected with first terminals provided at said manufacturers and second terminals provided in said stores,

said server provided with

entry means enabling input of product information of said products from said first terminals,

product information display means for sending said product information to and displaying it at said second terminals, and

acquiring means for acquiring histories by which said product information is accessed by said second terminals.

(Appendix 2)

A product purchasing trend analyzing system as set forth in claim 1, wherein said server is provided with:

means for acquiring from said first terminals histories by which product information of said products has been updated for each first terminal,

means for calculating an update history order for each said first terminal from an update history of each first terminal, and

means for evaluating an input of product information for each first terminal from said update history order.

(Appendix 3)

A product purchasing trend analyzing system as set forth in appendix 1 or 2, wherein said acquiring means acquires a first history as to which products' product information customers access.

(Appendix 4)

A product purchasing trend analyzing system as set forth in any one of appendixes 1 to 3, wherein said acquiring means acquires a second history as to which products customers purchase.

(Appendix 5)

A product purchasing trend analyzing system as set forth in any one of appendixes 1 to 4, wherein

said product information includes a plurality of items showing specifications of said products, and

said acquiring means acquires a third history as to which items among said plurality of items customers access.

(Appendix 6)

A product purchasing trend analyzing system as set forth in any one of appendixes 2 to 5, wherein

said product information includes a plurality of items showing specifications of said product, and

said acquiring means acquires said first history and said third history by store clerks accessing said second terminals for items designated by customers.

(Appendix 7)

A product purchasing trend analyzing system as set forth in appendix 5 or 6, where said third history is a history by which the same customers access a plurality of items among said plurality of items.

(Appendix 8)

A product purchasing trend analyzing system as set forth in any one of appendixes 5 to 7, wherein said server is provided with a customer purchasing trend database storing at least one of the first, second, and third histories acquired by said acquiring means.

(Appendix 9)

A product purchasing trend analyzing system as set forth in appendix 8, wherein

said system is provided with a customer purchasing trend database for storing information giving a first history as to what products' product information said customers access, a second history as to which products said customers have purchased, and a third history as to which items among a plurality of items showing specifications of said products said customers access, and

said server counts the number of times customers access predetermined product categories in said product information in product category units, stores the counted values in said customer purchasing trend database, reads from said customer purchasing trend database if said customers have purchased products and reads what items among the plurality of items showing specifications of said products said customers accessed, and displays purchasing trends of products so as to analyze the reasons why said customers selected the manufacturers whose products said customers have purchased, from among a plurality of manufacturers providing product information of said products which said customers access, by provision of first display means.

(Appendix 10)

A product purchasing trend analyzing system as set forth in appendix 8, wherein

said system is provided with a customer purchasing trend database for storing information giving a first history as to what products' product information said customers access, a second history as to which products said customers have purchased, and a third history as to which items among a plurality of items showing specifications of said products said customers access, and

said server counts the number of times customers access predetermined product categories in said product information in product category units, stores the counted values in said customer purchasing trend database, reads from said customer purchasing trend database if said customers have purchased products of said product category, and displays a list comparing for each product category the manufacturers for which customers view said product categories or purchase from, from among a plurality of manufacturers providing product information of products of said product categories accessed by said customers, by provision of second display means.

(Appendix 11)

A product purchasing trend analyzing system as set forth in appendix 8, wherein

said system is provided with a customer purchasing trend database for storing information giving a first history as to what products' product information said customers access, a second history as to which products said customers have purchased, and a third history as to which items among a plurality of items showing specifications of said products said customers access, and

said server counts the number of times customers access predetermined product categories in said product information in product category units, stores the counted values in said customer purchasing trend database, reads from said customer purchasing trend database if said customers have purchased products of said product categories and reads which items among a plurality of items showing specifications of said products said customers have accessed, and displays a list comparing, for each product category, the number of times said customers have accessed a plurality of items showing specifications of said products of manufacturers compared with a specific manufacturer among a plurality of manufacturers providing product information of products of said product category which said customer accesses with said specific manufacturer for each manufacturer by provision of a third display means.

(Appendix 12)

A product purchasing trend analyzing system as set forth in appendix 1, wherein the system is provided with a second server separate from said server provided with said acquiring means, and said second server stores information giving a first history as to what products' product information said customers access, a second history as to which products said customers have purchased, and a third history as to which items among a plurality of items showing specifications of said products said customers access and sets the restocking quantities and prices of the products.

(Appendix 13)

A product purchasing trend analyzing system as set forth in appendix 1, which system acquires histories of the times when customers view product information and the times when they purchase said products and obtains statistics on the number of viewings of individual products and how many days after viewing the product information which products were purchased so as to set restocking quantities and restocking dates of individual products based on the histories of said viewing times and said purchasing times.

(Appendix 14)

A program in a product purchasing trend analyzing system for analyzing purchasing trends of products which manufacturers sell in stores,

said program in a product purchasing trend analyzing system characterized by being provided with:

entry means enabling input of product information of said products from said first terminals,

product information display means for sending said product information to and displaying it at said second terminals, and

acquiring means for acquiring histories by which said product information is accessed by said second terminals.

1. A product purchasing trend analyzing system for analyzing purchasing trends of products which manufacturers sell in stores,
said product purchasing trend analyzing system characterized by being provided with a server communicably connected with first terminals provided at said manufacturers and second terminals provided in said stores,
said server provided with
entry means enabling input of product information of said products from said first terminals,
product information display means for sending said product information to and displaying it at said second terminals, and
acquiring means for acquiring histories by which said product information is accessed by said second terminals.

2. A product purchasing trend analyzing system as set forth in claim 1, wherein
said system is provided with a customer purchasing trend database for storing information giving a first history as to what products' product information said customers access, a second history as to which products said customers have purchased, and a third history as to which items among a plurality of items showing specifications of said products said customers access, and
said server counts the number of times customers access predetermined product categories in said product information in product category units, stores the counted values in said customer purchasing trend database, reads from said customer purchasing trend database if said customers have purchased products and reads what items among the plurality of items showing specifications of said products said customers accessed, and displays purchasing trends of products so as to analyze the reasons why said customers selected the manufacturers whose products said customers have purchased, from among a plurality of manufacturers providing product information of said products which said customers access, by provision of first display means.

3. A product purchasing trend analyzing system as set forth in claim 1, wherein
said system is provided with a customer purchasing trend database for storing information giving a first history as to what products' product information said customers access, a second history as to which products said customers have purchased, and a third history as to which items among a plurality of items showing specifications of said products said customers access, and
said server counts the number of times customers access predetermined product categories in said product information in product category units, stores the counted values in said customer purchasing trend database, reads from said customer purchasing trend database if said customers have purchased products of said product category, and displays a list comparing for each product category the manufacturers for which customers view said product categories or purchase from, from among a plurality of manufacturers providing product information of products of said product categories accessed by said customers, by provision of second display means.

4. A product purchasing trend analyzing system as set forth in claim 1, wherein
said system is provided with a customer purchasing trend database for storing information giving a first history as to what products' product information said customers access, a second history as to which products said customers have purchased, and a third history as to which items among a plurality of items showing specifications of said products said customers access, and
said server counts the number of times customers access predetermined product categories in said product information in product category units, stores the counted values in said customer purchasing trend database, reads from said customer purchasing trend database if said customers have purchased products of said product categories and reads which items among a plurality of items showing specifications of said products said customers have accessed, and displays a list comparing, for each product category, the number of times said customers have accessed a plurality of items showing specifications of said products of manufacturers compared with a specific manufacturer among a plurality of manufacturers providing product information of products of said product category which said customer accesses with said specific manufacturer for each manufacturer by provision of a third display means.

5. A product purchasing trend analyzing system as set forth in claim 1, wherein the system is provided with a second server separate from said server provided with said acquiring means, and said second server stores information giving a first history as to what products' product information said customers access, a second history as to which products said customers have purchased, and a third history as to which items among a plurality of items showing specifications of said products said customers access and sets the restocking quantities and prices of the products.
